(19) United States
(12) Patent Application Publication
(10) Pub. No.: US 2025/0341121 A1
(43) Pub. Date: Nov. 6, 2025

(54) VEHICLE DOOR HANDLE

(71) Applicant: Rivian IP Holdings, LLC, Irvine, CA (US)

(72) Inventors: Mirisage Niral Sachinthana Fernando, Lake Forest, CA (US); Aakash Mali, Daly City, CA (US); Steven Hang, Long Beach, CA (US); Cory Ibanez, San Jose, CA (US); Vivek Ravi, San Jose, CA (US); Brandon Louis Fennema, Rancho Santa Margarita, CA (US)

(73) Assignee: Rivian IP Holdings, LLC, Irvine, CA (US)

(21) Appl. No.: 19/198,770

(22) Filed: May 5, 2025

Related U.S. Application Data
(60) Provisional application No. 63/643,355, filed on May 6, 2024.

(51) Int. Cl. E05B 81/76; E05B 85/14

(52) U.S. Cl. CPC E05B 81/76; E05B 85/14

(57) ABSTRACT

An apparatus can include circuitry. The circuitry can be disposed within a component of a vehicle. The circuitry can include a transceiver. The transceiver can receive a first signal to indicate a first interaction with the component of the vehicle. The circuitry can include a sensor. The sensor can detect a second interaction with the component of the vehicle. The first interaction or the second interaction can cause a change to the component of the vehicle.

### CROSS-REFERENCE TO RELATED PATENT APPLICATIONS

This application claims the benefit of and priority to U.S. Provisional Patent Application No. 63/643,355, filed on May 6, 2024, the entirety of which is incorporated by reference herein.

### INTRODUCTION

Vehicles can include door handles to provide access to the vehicles.

### SUMMARY

This disclosure is generally related to one or more devices of a vehicle. The devices can include an apparatus. The apparatus can include circuitry. For example, the apparatus can include hardware or otherwise physical circuitry components. The apparatus can be disposed within a vehicle. For example, the apparatus can be housed or otherwise located within a door handle of the vehicle. The apparatus can detect at least one interaction with the door handle. For example, the apparatus can detect contact (e.g., an interaction) with the door handle. As another example, the apparatus can receive one or more signals that indicate the presence of a device (e.g., an interaction).

At least one aspect is directed to an apparatus. The apparatus can include circuitry. The circuitry can be disposed within a component of a vehicle. The circuitry can include a transceiver. The transceiver can receive a first signal to indicate a first interaction with the component of the vehicle. The circuitry can include a sensor. The sensor can detect a second interaction with the component of the vehicle. The first interaction or the second interaction can cause a change to the component of the vehicle.

At one aspect is directed to an apparatus. The apparatus can include a transceiver. The transceiver can receive a first signal to indicate a first interaction with a component of a vehicle. The apparatus can include a sensor. The sensor can detect a second interaction with the component of the vehicle. The first interaction or the second interaction can cause a change to the component of the vehicle.

At least one aspect is directed to a vehicle. The vehicle can include a door handle assembly. The door handle assembly can include a transceiver. The transceiver can receive a first signal to indicate a first interaction with the door handle assembly. The door handle assembly can include a sensor. The sensor can detect a second interaction with the door handle assembly. The first interaction or the second interaction can cause a change to the component of the vehicle.

At least one aspect is directed to a method. The method can include receiving, by a transceiver of an apparatus, a first signal to indicate a first interaction with a component of a vehicle. The method can include detecting, by a sensor of the apparatus, a second interaction with the component of the vehicle. The first interaction or the second interaction can cause a change to the component of the vehicle.

At least one aspect is directed to an apparatus. The apparatus can include circuitry. The circuitry can dispose within a door handle of a vehicle. The circuitry can include a transceiver. The transceiver can receive a first signal to indicate a first interaction with the door handle. The circuitry can include a sensor. The sensor can detect a second interaction with the door handle. The circuitry can include one or more processors, coupled with memory. The one or more processors can detect at least one of the first interaction or the second interaction. The one or more processors can cause, responsive to detection of at least one of the first interaction or the second interaction, a change in a state of the door handle.

At least one aspect is directed to a vehicle. The vehicle can include a door handle assembly. The door handle assembly can include a transceiver. The transceiver can receive a first signal to indicate a first interaction with the door handle assembly. The door handle assembly can include a sensor. The sensor can detect a second interaction with the door handle assembly. The first interaction or the second interaction can cause a change in a state of the door handle assembly of the vehicle.

At least one aspect is directed to a printed circuit board. The printed circuit board can include a transceiver. The transceiver can receive a first signal to indicate a first interaction with a door handle. The transceiver can at least partially surround a sensor along a first portion of the printed circuit board. The printed circuit board can include the sensor. The sensor can detect a second interaction with the door handle. The printed circuit board can include one or more processors, coupled with memory. The one or more processors can detect at least one of the first interaction or the second interaction. The one or more processors can cause, responsive to detection of at least one of the first interaction or the second interaction, a change in a state of the door handle.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts an electric vehicle, in accordance with an implementation.

FIG. 2 depicts a perspective view of the electric vehicle illustrated in FIG. 1, in accordance with an implementation.

FIG. 3 depicts a perspective view of the electric vehicle illustrated in FIG. 1, in accordance with an implementation.

FIG. 4 depicts a perspective view of an apparatus illustrated in FIG. 3, in accordance with an implementation.

FIG. 5 depicts a perspective view of a printed circuit board (PCB), in accordance with an implementation.

FIG. 6 depicts a block diagram of one or more components of the apparatus illustrated in FIG. 4, in accordance with an implementation.

FIG. 7 depicts a workflow to process signals produced or detected by at least one sensor, in accordance with an implementation.

FIG. 8 depicts a block diagram illustrating an architecture for a computer system that can be employed to implement elements of the systems and methods described and illustrated herein.

### DETAILED DESCRIPTION

Following below are more detailed descriptions of various concepts related to, and implementations of, methods, apparatuses, and systems of circuitry for an apparatus. The various concepts introduced above and discussed in greater detail below may be implemented in any of numerous ways.

The present disclosure is directed to systems and methods of one or more devices for a vehicle. The devices can include an apparatus. The apparatus can include circuitry to disposed within at least one component of a vehicle. For example, the apparatus can be located within a door panel of the vehicle. As another example, the circuitry can be situated within a door handle. The circuitry can include a transceiver and a sensor. The transceiver can receive one or more signals. For example, the transceiver can receive at least one near-field communication (NFC) signal. The transceiver can receive signals to indicate interactions with the apparatus. For example, the transceiver can receive a signal that indicates an interaction between a mobile device and the apparatus. The sensor can detect at least one interaction. For example, the sensor can detect contact with the apparatus (e.g., an object contacted the door handle).

Vehicles can include various access methods. For example, a vehicle can include a door handle with a capacitive sensor that detects contact with the door handle. As another example, a vehicle can include a receiver that can detect the presence of a device proximate to the vehicle. These various access methods include locating devices at different points of the vehicle. The varying locations of the devices can limit feasibility or accessibility to the access methods. For example, a first access method may include devices located at a first location of the vehicle. To continue this example, the first location can only include devices associated with the first access method. As such, interactions with the devices associated with the first access method are limited to interactions that pertain to the first access method. Moreover, these devices are prone to mechanical replacement or complications due to the elements (e.g., rain, dust, debris, etc.).

The disclosed solutions have a technical advantage of providing an apparatus that includes a unified access point for a vehicle. For example, the apparatus can include a force sensor and a near-field communication (NFC) antenna. To continue this example, the apparatus can be located within a door handle of the vehicle. The apparatus can provide a unified access point by having various access methods included within the same circuitry. Stated otherwise, a single location of the vehicle can include multiple access methods to provide a collocated region or area for a user to interact with the vehicle to gain access to the vehicle.

The force sensor can be disposed or otherwise located at the middle of the NFC antenna. For example, the NFC antenna can surround the force sensor. The force sensor and the NFC antenna can be located behind a surface dimple of the vehicle. For example, the force sensor and the NFC antenna can be housed on a printed circuit board (PCB) that is located behind or underneath the surface dimple. The location of the force sensor and the NFC antenna behind the surface dimple can provide a unified access point as physical contact with the surface dimple can provide access to the vehicle responsive to detection of the contact by the force sensor. Moreover, detection of an NFC signal, by the NFC antenna, can provide access to the vehicle.

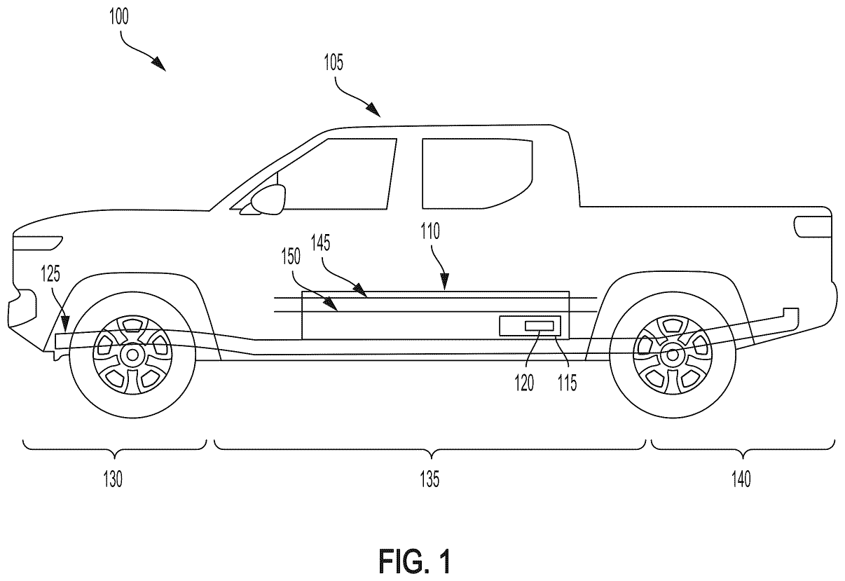

FIG. 1 depicts an example cross-sectional view 100 of an electric vehicle 105 installed with at least one battery pack 110. Electric vehicles 105 can include electric trucks, electric sport utility vehicles (SUVs), electric delivery vans, electric automobiles, electric cars, electric motorcycles, electric scooters, electric passenger vehicles, electric passenger or commercial trucks, hybrid vehicles, or other vehicles such as sea or air transport vehicles, planes, helicopters, submarines, boats, or drones, among other possibilities. The battery pack 110 can also be used as an energy storage system to power a building, such as a residential home or commercial building. Electric vehicles 105 can be fully electric or partially electric (e.g., plug-in hybrid) and further, electric vehicles 105 can be fully autonomous, partially autonomous, or unmanned. Electric vehicles 105 can also be human operated or non-autonomous. Electric vehicles 105 such as electric trucks or automobiles can include on-board battery packs 110, batteries 115, or battery cells 120 to power the electric vehicles. The batteries 115 can refer to or include at least one battery module.

The electric vehicle 105 can include a chassis 125 (e.g., a frame, internal frame, or support structure). The chassis 125 can support various components of the electric vehicle 105. The chassis 125 can span a front portion 130 (e.g., a hood or bonnet portion), a body portion 135, and a rear portion 140 (e.g., a trunk, payload, or boot portion) of the electric vehicle 105. The battery pack 110 can be installed or placed within the electric vehicle 105. For example, the battery pack 110 can be installed on the chassis 125 of the electric vehicle 105 within one or more of the front portion 130, the body portion 135, or the rear portion 140. The battery pack 110 can include or connect with at least one busbar, e.g., a current collector element. For example, the first busbar 145 and the second busbar 150 can include electrically conductive material to connect or otherwise electrically couple the batteries 115 or the battery cells 120 with other electrical components of the electric vehicle 105 to provide electrical power to various systems or components of the electric vehicle 105.

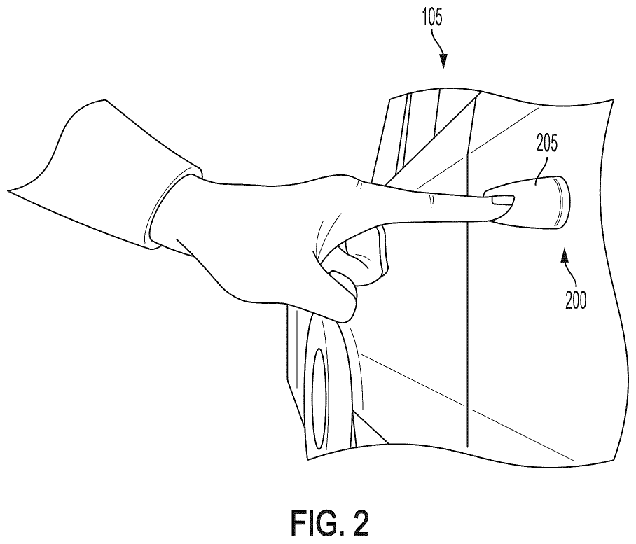

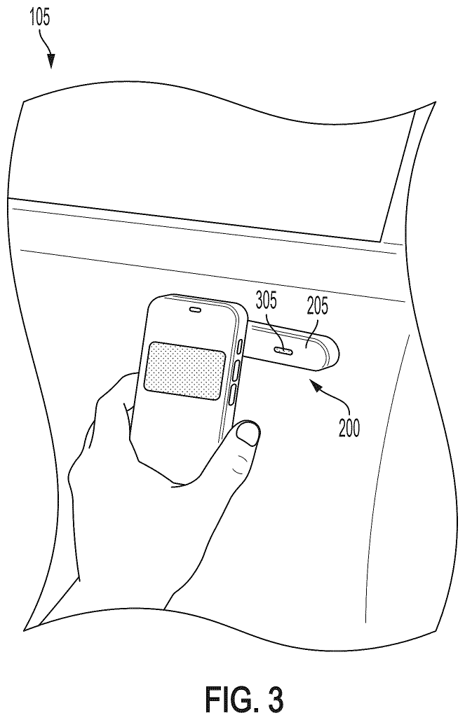

FIGS. 2-3 depict perspective views of the vehicle 105. The vehicle 105 can include at least one apparatus 200. For example, the apparatus 200 can be integrated with a door handle 205. The door handle 205 can refer to or include at least one door handle assembly of the vehicle 105. The apparatus 200 can include the apparatus described herein. For example, the apparatus 200 can provide a unified access point for the vehicle 105. Stated otherwise, the apparatus 200 can include multiple access methods that are located at a single access point (e.g., the door handle 205) of the vehicle 105 or otherwise collocated on the vehicle 105.

The door handle 205 can include at least one dimple 305. The dimple 305 can include the surface dimple described herein. The dimple 305 can be located on an external surface of the door handle 205. The dimple 305 can include at least one feature that differentiates the dimple 305 from the door handle 205. For example, the dimple 305 can be a first color and the door handle 205 can be a second color that is different from the first color. As another example, the dimple 305 can be raised or otherwise extended from the door handle 205.

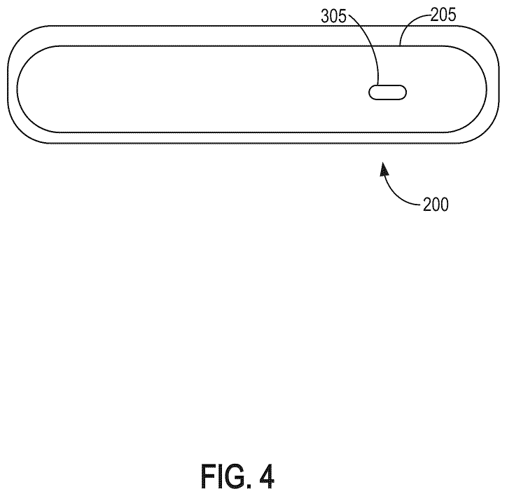

FIG. 4 depicts a perspective view of the apparatus 200. The apparatus 200 can be separate from the door handle 205. For example, the apparatus 200 can be provided as a separate component from that of the door handle 205. As another example, the apparatus 200 can be removable from the door handle 205. To continue this example, the apparatus 200 can be located within a cavity of the door handle 205. The dimple 305 can be offset from a center point of the door handle 205. For example, the dimple 305 can be located to the right of the center point of the door handle 205. In other examples, the dimple 305 can be located at various locations along or across the door handle 205,

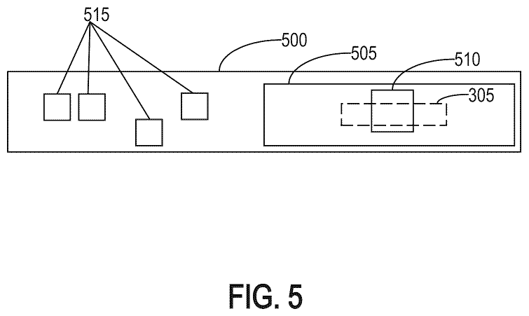

FIG. 5 depicts a perspective view of a printed circuit board (shown as PCB 500). The PCB 500 can include various circuitry. For example, the PCB 500 can include transistors, resisters, capacitors, inductors, connectors, logic gates, microcontrollers, analog to digital convertors, operational amplifiers, multiplexers, demultiplexers, general purpose input output (GPIO) pins, electrical connectors, or other possible electrical circuitry. The PCB 500 can represent the apparatus 200. For example, the PCB 500 can include various components of the apparatus 200. The apparatus 200 can include the PCB 500. For example, the PCB 500 can house various components of the apparatus 200.

The PCB 500 can include at least one Near-Field Communication device (shown as NFC 505), at least one sensor 510, and at least one component 515. The NFC 505 can include at least one of transceivers, receivers, relays, antennas, or transmitters. The NFC 505 can refer to or include at least one NFC antenna. The NFC 505 (or one or more components thereof) can surround the sensor 510. For example, as shown in FIG. 5, the NFC 505 can extend or travel around the sensor 510 on the PCB 500. The sensor 510 can include at least one of force sensors, accelerometers, pressure sensors, proximity sensors, or contact switches. The components 515 can include at least one of resistors, capacitors, inductors, transistors, relays, logic gates, microcontrollers, or other possible electrical hardware. As shown in FIG. 5, the dimple 305 can be located superficial to or otherwise located external to the NFC 505 and the sensor 510.

The NFC 505 can receive at least one signal. For example, the NFC 505 can receive a signal from a mobile device (e.g., a smart phone, a smart watch, a fob, a tablet, a laptop, a phone, etc.). The NFC 505 can receive the signals responsive to an interaction with the dimple 305. For example, the NFC 505 can receive a first signal responsive to a mobile device interacting with or otherwise interfacing with the dimple 305. The signals can indicate one or more interactions with the vehicle 105. For example, the signals can indicate that a mobile device tapped or otherwise interfaced with door handle 205.

The sensor 510 can detect one or more interactions with the door handle 205. For example, the sensor 510 can detect contact with the door handle 205. As another example, the sensor 510 can detect pressure applied to the door handle 205. The interactions with the door handle 205 (e.g., interfacing with the dimple 305, contacting the door handle 205, receiving signals, etc.) can indicate an intent to enter the vehicle 105. For example, the NFC 505 receiving an NFC signal from an authenticated device can indicate an intention to enter the vehicle 105.

The interactions with the door handle 205 can cause changes to the door handle 205. For example, the door handle 205 can move from a stowed position to a deployed position responsive to the NFC 505 receiving a signal from an authenticated device. As another example, the door handle 205 can move to a deployed position responsive to the sensor 510 detecting contact with the dimple 305. Stated otherwise, a state (e.g., a position, a placement, a configuration, an arrangement, etc.) of the door handle 205 can change based on one or more interactions with the door handle 205.

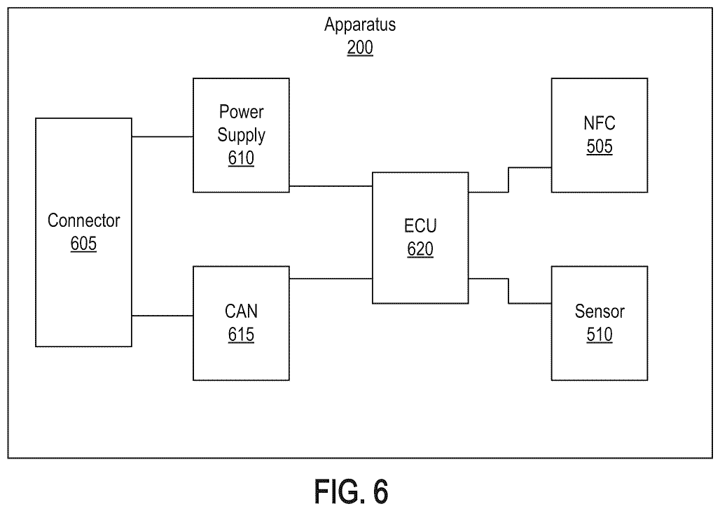

FIG. 6 depicts a block diagram of the apparatus 200. The apparatus 200 can include at least one connector 605, at least one power supply 610, at least one controller area network (shown as CAN 615), at least one electronic control unit (shown as ECU 620), the NFC 505, and the sensor 510. The various components of the apparatus 200 can be communicably coupled with one another. For example, the CAN 615 can couple the ECU 620 with the connector 605. As another example, the ECU 620 can be communicably coupled with the NFC 505 and the sensor 510.

The connector 605 can include at least one of cables, cords, electrical connectors, or other possible components to electrically couple devices with one another. The power supply 610 can include at least one of batteries, energy storage devices, or other possible devices that can provide power. The power supply 610 can provide power to various components of the apparatus 200. For example, the power supply 610 can provide electrical power to the ECU 620. As another example, the power supply 610 can power the NFC 505.

The ECU 620 can include at least one of controllers, microcontrollers, digital signal processing devices, processors, memory, logic devices, system on chip (SoC), or other possible embedded devices. The ECU 620 can receive at least one signal. For example, the ECU 620 can receive signals from the NFC 505. As another example, the ECU 620 can receive signals from the sensor 510.

The ECU 620 can receive at least one signal from the NFC 505. For example, the ECU 620 can receive signals from the NFC 505 responsive to the NFC 505 receiving NFC signals. As another example, the ECU 620 can receive signals from the NFC 505 at one or more time increments. To continue this example, the NFC 505 can ping or otherwise probe for NFC devices or NFC communication at least one or points in time. The ECU 620 can receive or otherwise detect the pings or probes. The receipt of the signals from the NFC 505 can produce noise or interference with the sensor 510. For example, the NFC 505 can produce signals that muddle or otherwise dilute signals produced by the sensor 510.

The ECU 620 can modify signals produced by the NFC 505. For example, the ECU 620 can implement various algorithms (e.g., one or more rules) to filter or otherwise isolate signals produced by the NFC 505 from signals produced by the sensor 510. Stated otherwise, the ECU 620 can distinguish signals produced by the NFC 505 from signals produced by the sensors 510. The ECU 620 can implement or utilize one or more detectors to distinguish signals. For example, the ECU 620 can include a fuzzy-peak detector that can recognize edges (e.g., ranges, peaks, valleys, etc.) of signals produced by the NFC 505. The ECU 620 can implement or include at least one protocol. For example, the ECU 620 can implement an inter-integrated circuit (I2C) protocol.

The various lines (e.g., connectors, cables, wires, wiring, soldering, lanes, etc.) of the apparatus 200 or the PCB 500 can include multiple accesses to ground (e.g., GND) such that noise produced by the NFC 505 is reduced as a result of a minimal distance to GND. Each component or device of the PCB 500 can include lanes to power or ground. For example, the sensor 510 can have a lane, along or on the PCB 500, to power and ground. The components having lanes to power and ground can maximize power distribution across the PCB 500. Moreover, the sensor 510 can receive power without planes or decoupling capacitors.

Access to the vehicle 105 can be provided responsive to receipt or detection of at least one form of authentication. For example, a mobile device can store a mobile application that is accessible via a PIN or other possible unique number. To continue this example, once access to the mobile application is authenticated, the mobile device can produce an NFC signal to indicate an intent to access the vehicle 105. The NFC signal can include information to authenticate the mobile device. The ECU 620 can authenticate the mobile device. For example, the ECU 620 can detect a match between a device ID included in the NFC signal and a device ID stored by the ECU 620 in memory. Stated otherwise, the ECU 620 may query one or more sets of information (stored in memory) to search for a match. The ECU 620 can also authenticate access to the vehicle 105 by various methods. For example, the ECU 620 can authenticate access to the vehicle 105 responsive to detection of a fob associated with the vehicle 105.

As an example, the sensor 510 can detect contact with the door handle 205 (e.g., an operator of the vehicle 105 touched or otherwise interfaced with the door handle 205). To continue this example, the sensor 510 can transmit one or more signals to the ECU 620. The signals can include raw data produced by the sensor 510. To continue this example, the detector of the apparatus 200 can produce signals to indicate peaks (e.g., NFC signals received by the NFC 505). The detector can transmit the signals to the ECU 620 via the CAN 615. The ECU 620 can receive the signals transmitted by the sensor 510 or the ECU 620 can receive the signals transmitted by the NFC 505. To continue this example, the ECU 620 can monitor interactions with the door handle 205 (e.g., attempts to move, interface with, touch, interact with, etc.). In this example, the ECU 620 can process or otherwise analyze information to determine if the information provides an indication of an authenticated access attempt. To continue this example, the ECU 620 can authenticate the access attempt based on information collected by the NFC 505 or based on a detection of various authenticated devices proximate to the vehicle 105. In this example, the ECU 620 can transmit one or more signals to the door handle 205 to cause the door handle 205 to deploy (e.g., activate an actuator, release a latch, deactivate a locking mechanism, etc.).

The NFC 505 can at least partially surround the sensor 510. For example, the NFC 505 can extend along the PCB 500 to surround the sensor 510 on the PCB 500. As another example, the NFC 505 can completely surround the sensor 510 on the PCB 500. The NFC 505 and the sensor 510 can be housed on the same half of the PCB 500. For example, the NFC 505 and the sensor 510 can be located on a right half of the PCB 500. The apparatus 200 can be disposed within a component of the vehicle 105. For example, the apparatus 200 can be disposed within the door handle 205. The door handle 205 can include the dimple 305.

The ECU 620 can receive one or more signals sequential to or subsequent to one another. For example, the ECU 620 can receive one or more first signals from the NFC 505. To continue this example, the ECU 620 can receive one or more signals from the sensor 510 to indicate detection of an interactions. The signals transmitted by the NFC 505 or the sensor 510 can include time periods. For example, the sensor 510 can detect interactions with the door handle 205 within ten seconds of the NFC 505 receiving a signal. In other examples, there can be various amounts of time or durations of time between the signals or detection of signals.

The NFC 505 and the sensor 510 can be separated from one another on the PCB 500. For example, the NFC 505 and the sensor 510 can be separated by a distance less than 10 centimeters. As another example, the NFC 505 and the sensor 510 can be separated by a quarter of an inch on the PCB 500. The NFC 505 and the sensor 510 can be disposed on the PCB 500. The PCB 500 can be disposed within a component of the vehicle 105. For example, the PCB 500 can be disposed within the door handle 205.

A process to provide a unified access point can include receiving, by a transceiver of an apparatus, a first signal to indicate a first interaction with a component of a vehicle. For example, the NFC 505 can receive a first signal from a smart phone. The fist signal can indicate a first interaction with a component of a vehicle. For example, the first signal can indicate a first interaction with the dimple 305. The process can include detecting, by a sensor of the apparatus, a second interaction with the component of the vehicle. For example, the sensor 510 can detect an interaction with the dimple 305. To continue this example, the sensor 510 can detect the interaction responsive to detection of pressure on the dimple 305. The first interaction or the second interaction to cause a change to the component of the vehicle. For example, the door handle 205 can move from a stowed position to a deployed position responsive to receipt of the first signal by the NFC 505. As another example, the door handle 205 can unlock responsive to detection of the second interaction with the door handle 205. Stated otherwise, one or more authenticated interactions with the door handle 205 can result in a change of state (e.g., locked to unlocked, unlocked to lock, etc.).

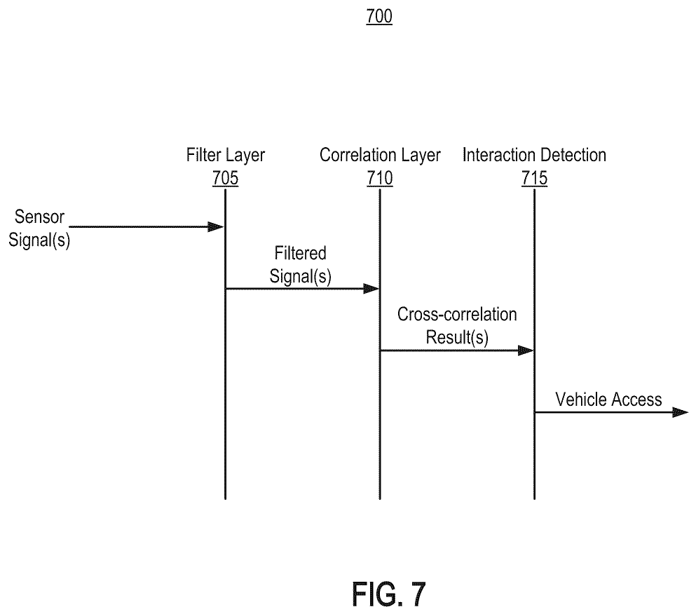

FIG. 7 depicts a workflow 700 to process one or more signals, in accordance with an implementation. At least one device, component, assembly, circuitry, or computing device described herein can perform the workflow 700 or one or more steps thereof. For example, The ECU 620 can implement the workflow 700. As another example, one or more processors, coupled with memory, can perform at least one step of the workflow 700. While the workflow 700 may illustrate or indicate a given flow or directionality, this is for illustrative purposes only and is in no way limiting. For example, one or more first steps of the workflow 700 can be repeated, reproduced, replicated, or otherwise performed prior to performance of one or more second steps. As another example, one or more steps of the workflow 700 can be omitted, skipped, avoided, or otherwise not performed.

As described herein, the sensor 510 and the NFC 505 can be located proximate to, near, or otherwise collocated by one another. Stated otherwise, the sensor 510 and the NFC 505 a positioned close to one another. As a result of the collocation between the sensor 510 and the NFC 505, the sensors 510 can be triggered or activated responsive to transmission, by the NFC 505, one or more NFC polls or prompting signals. Stated otherwise, the NFC polling signals can introduce noise or interference proximate to the sensor 510 which can cause the sensor 510 to interpret the NFC polling signals as interactions (e.g., touches) with the door handle 205. Implementation or execution of a filter function or routine, which implements one or more steps of the workflow 700, can account for or filter out false positive signals transmitted by the sensor 510. Stated otherwise, implementation of the filter function can assist with distinguishes NFC polling signals (detected by the sensor 510) and touch interactions (detected by the sensor 510).

The workflow can include at least one filtering layer 705. The filtering layer 705 initiate or originate upon receipt of one or more sensor signals can be received. For example, the filtering layer 705 can be instantiated responsive to the ECU 620 receiving one or more signals transmitted by the sensor 510. As another example, the filtering layer 705 can include the ECU 620 detecting one or more signals transmitted by the NFC 505. The filtering layer 705 can implement or execute one or more filters or filtering devices. For example, the filtering layer 705 can implement a clipping filter. The clipping filter can eliminate saturation of one or more signals which were induced or cause by the noise associated with NFC polling.

The filtering layer 705 can implement a median filter. The median filter can reduce instrument noise associated with operation of the sensor 510. The filtering layer 705 can implement an exponential weighted moving average (EWMA) filter. The EWMA filter can smooth force touch signals (e.g., signals associated with a touch or interaction with the door handle 205). The filtering layer 705 can implement a Kalman filter or Bayesian type filter. The Kalman filter can remove sudden changes in force touch measurements that fall outside of an estimated or predicted signal strength associated with a touch of the door handle 205. Implementation of the filtering layer 705 can yield or otherwise output one or more filter signals.

The workflow 700 can include at least one correlation layer 710. Implementation of the correlation layer 710 can include analyzing or otherwise cross correlating the filter signals (output by the filtering layer 705) with one or more known or reference signals. The correlation layer 710 can detect or determine a likeness or similarity between the signals. For example, the reference signal can include a discernable or identifiable shape (e.g., a square wave, a triangle wave, etc.). The correlation layer can filter the signals using information beyond just the initial peak or signal strength of signals.

The correlation layer 710 can normalize force touch signals to accommodate for differences between one or more type of touch (e.g., long touch, short touch, etc.) or other types of touches (e.g., grabbing door handle, handle retraction, handle deployment, door closure, door opening, etc.). The correlation layer 710 can output or otherwise provide one or more correlation values (e.g., similarities between the filter signals and the reference signals).

The workflow 700 can include at least one interaction detection 715. The interaction detection 715 can include the analysis or evaluation of the correlation values (output by the correlation layer 710) to discern one or more indications or interactions associated with given signals. For example, the interaction detection 715 can include a detection that a given signal is associated with a force touch of the door handle 205. Upon detection of the force touch, the interaction detection 715 can transmit one or more signals to trigger or otherwise cause a change in a state of the door handle 205. For example, the interaction detection 715 can cause the door handle 205 to be in an unlocked state. As another example, the interaction detection 715 can cause the door handle 205 to be in a deployed state.

The interaction detection 715 can implement one or more stages to evaluate the correlation layers. For example, the interaction detection 715 can implement a post processing stage (such as a debouncer) to reject repeated force touch triggers that occurred within a given time window during which an initial or original force touch is processed. As another example, the interaction detection 715 can use one or more vehicle events (e.g., door open, door close, device detection, authentication, drive state, etc.) to block or otherwise filter false force touch which can be triggered by occurrences of the vehicle events.

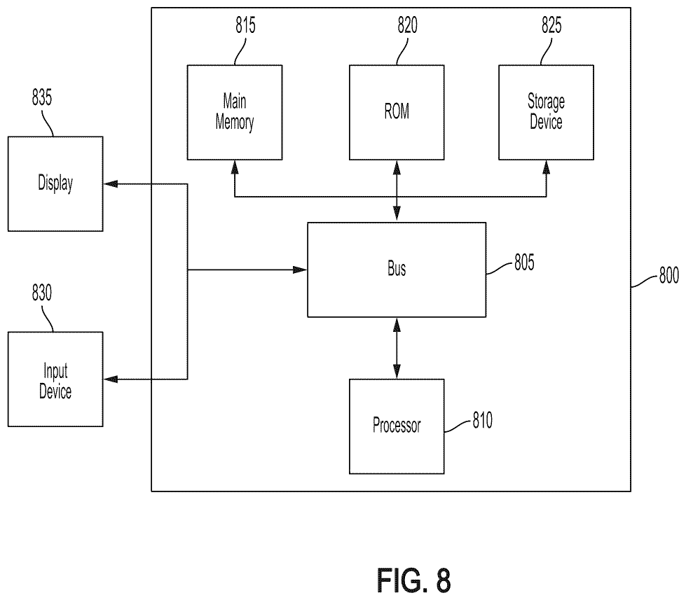

FIG. 8 depicts an example block diagram of an example computer system 800. The computer system 800 can include or be used to implement a data processing system or its components. The computer system 800 includes at least one bus 805 or other communication component for communicating information and at least one processor 810 or processing circuit coupled to the bus 805 for processing information. The computer system 800 can also include one or more processors 810 or processing circuits coupled to the bus for processing information. The computer system 800 also includes at least one main memory 815, such as a random access memory (RAM) or other dynamic storage device, coupled to the bus 805 for storing information, and instructions to be executed by the processor 810. The main memory 815 can be used for storing information during execution of instructions by the processor 810. The computer system 800 may further include at least one read only memory (ROM) 820 or other static storage device coupled to the bus 805 for storing static information and instructions for the processor 810. A storage device 825, such as a solid state device, magnetic disk or optical disk, can be coupled to the bus 805 to persistently store information and instructions.

The computer system 800 may be coupled via the bus 805 to a display 835, such as a liquid crystal display, or active matrix display, for displaying information to a user such as a driver of the electric vehicle 105 or other end user. An input device 830, such as a keyboard or voice interface may be coupled to the bus 805 for communicating information and commands to the processor 810. The input device 830 can include a touch screen display 835. The input device 830 can also include a cursor control, such as a mouse, a trackball, or cursor direction keys, for communicating direction information and command selections to the processor 810 and for controlling cursor movement on the display 835.

The processes, systems and methods described herein can be implemented by the computer system 800 in response to the processor 810 executing an arrangement of instructions contained in main memory 815. Such instructions can be read into main memory 815 from another computer-readable medium, such as the storage device 825. Execution of the arrangement of instructions contained in main memory 815 causes the computer system 800 to perform the illustrative processes described herein. One or more processors in a multi-processing arrangement may also be employed to execute the instructions contained in main memory 815. Hard-wired circuitry can be used in place of or in combination with software instructions together with the systems and methods described herein. Systems and methods described herein are not limited to any specific combination of hardware circuitry and software.

Although an example computing system has been described in FIG. 8, the subject matter including the operations described in this specification can be implemented in other types of digital electronic circuitry, or in computer software, firmware, or hardware, including the structures disclosed in this specification and their structural equivalents, or in combinations of one or more of them.

Some of the description herein emphasizes the structural independence of the aspects of the system components or groupings of operations and responsibilities of these system components. Other groupings that execute similar overall operations are within the scope of the present application. Modules can be implemented in hardware or as computer instructions on a non-transient computer readable storage medium, and modules can be distributed across various hardware or computer based components.

The systems described above can provide multiple ones of any or each of those components and these components can be provided on either a standalone system or on multiple instantiation in a distributed system. In addition, the systems and methods described above can be provided as one or more computer-readable programs or executable instructions embodied on or in one or more articles of manufacture. The article of manufacture can be cloud storage, a hard disk, a CD-ROM, a flash memory card, a PROM, a RAM, a ROM, or a magnetic tape. In general, the computer-readable programs can be implemented in any programming language, such as LISP, PERL, C, C++, C #, PROLOG, or in any byte code language such as JAVA. The software programs or executable instructions can be stored on or in one or more articles of manufacture as object code.

Example and non-limiting module implementation elements include sensors providing any value determined herein, sensors providing any value that is a precursor to a value determined herein, datalink or network hardware including communication chips, oscillating crystals, communication links, cables, twisted pair wiring, coaxial wiring, shielded wiring, transmitters, receivers, or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), or digital control elements.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device,” “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements, and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’”' can include only ‘A,’ only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes, and omissions can also be made in the design, operating conditions and arrangement of the disclosed elements and operations without departing from the scope of the present disclosure.

For example, descriptions of positive and negative electrical characteristics may be reversed. Elements described as negative elements can instead be configured as positive elements and elements described as positive elements can instead by configured as negative elements. For example, elements described as having first polarity can instead have a second polarity, and elements described as having a second polarity can instead have a first polarity. Further relative parallel, perpendicular, vertical, or other positioning or orientation descriptions include variations within +/−10% or +/−10 degrees of pure vertical, parallel, or perpendicular positioning. References to “approximately,” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. An apparatus, comprising:
circuitry to dispose within a door handle of a vehicle; and
the circuitry including:
a transceiver configured to receive a first signal to indicate a first interaction with the door handle;
a sensor configured to detect a second interaction with the door handle; and
one or more processors, coupled with memory, to:
detect at least one of the first interaction or the second interaction; and
cause, responsive to detection of at least one of the first interaction or the second interaction, a change in a state of the door handle.

2. The apparatus of claim 1, wherein the first signal includes information to authenticate a device associated with transmission of the first signal, and further comprising:
the one or more processors to:
receive, from the transceiver, at least one second signal which includes (i) the information to authenticate the device and (ii) an indication of the first interaction;
authenticate, based at least on a match between the information to authenticate the device and one or more sets of information stored in the memory, the device; and
transmit, to the door handle, one or more third signals to cause the change in the state of the door handle.

3. The apparatus of claim 1, further comprising:
the transceiver configured to transmit at least one second signal to prompt a device to transmit the first signal, wherein the at least one second signal is detectable by the sensor, and wherein detection of the at least one second signal, by the sensor, causes the sensor to transmit at least one third signal; and
the one or more processors to:
receive, from the sensor, the at least one third signal; and
execute a filter function to distinguish the at least one third signal from at least one fourth signal which indicates the second interaction.

4. The apparatus of claim 1, further comprising:
the one or more processors to:
detect one or more second signals transmitted by the transceiver; and
modify, based on one or more rules, the one or more second signals to distinguish from one or more third signals detectable by the sensor.

5. The apparatus of claim 1, further comprising:
a printed circuit board configured to house the circuitry;
the transceiver and the sensor disposed on a first portion of the printed circuit board; and
the transceiver configured to at least partially surround the sensor on the printed circuit board.

6. The apparatus of claim 1, further comprising:
a printed circuit board configured to house the circuitry; and
the transceiver configured to extend along at least a portion of the printed circuit board to surround the sensor on the printed circuit board.

7. The apparatus of claim 1, further comprising:
a dimple to dispose on an external surface of the door handle; and
at least one of the transceiver or the sensor to disposed behind the external surface.

8. The apparatus of claim 1, further comprising:
a printed circuit board to house the circuitry;
wherein the transceiver and the sensor are separated on the printed circuit board by a distance less than 10 centimeters.

9. The apparatus of claim 1, wherein the second interaction is detected within ten seconds of the first signal.

10. The apparatus of claim 1, wherein the change in the state of the door handle includes the door handle being unlocked to provide access to the vehicle.

11. A vehicle, comprising:
a door handle assembly, including:
a transceiver configured to receive a first signal to indicate a first interaction with the door handle assembly; and
a sensor configured to detect a second interaction with the door handle assembly; and
the first interaction or the second interaction to cause a change in a state of the door handle assembly of the vehicle.

12. The vehicle of claim 11, wherein the first signal includes information to authenticate a device associated with transmission of the first signal, and further comprising:
the door handle assembly in communication with one or more processors, coupled with memory, and the one or more processors to:
receive, from the transceiver, at least one second signal which includes (i) the information to authenticate the device and (ii) an indication of the first interaction;
authenticate, based at least on a match between the information to authenticate the device and one or more sets of information stored in the memory, the device; and
transmit, to the door handle assembly, one or more third signals to cause the change in the state of the door handle assembly.

13. The vehicle of claim 11, further comprising:
the transceiver configured to transmit at least one second signal to prompt a device to transmit the first signal, wherein the at least one second signal is detectable by the sensor, and wherein detection of the at least one second signal, by the sensor, causes the sensor to transmit at least one third signal; and
the door handle assembly in communication with one or more processors, coupled with memory, and the one or more processors to:
receive, from the sensor, the at least one third signal; and
execute a filter function to distinguish the at least one third signal from at least one fourth signal which indicates the second interaction.

14. The vehicle of claim 11, further comprising:
the door handle assembly in communication with one or more processors, coupled with memory, and the one or more processors to:
detect one or more second signals transmitted by the transceiver; and
modify, based on one or more rules, the one or more second signals to distinguish from one or more third signals detectable by the sensor.

15. The vehicle of claim 11, further comprising:
a printed circuit board configured to house circuitry of the door handle assembly;
the transceiver and the sensor disposed on a first portion of the printed circuit board; and
the transceiver configured to at least partially surround the sensor on the printed circuit board.

16. The vehicle of claim 11, further comprising:
a printed circuit board configured to house circuitry of the door handle assembly; and
the transceiver configured to extend along at least a portion of the printed circuit board to surround the sensor on the printed circuit board.

17. The vehicle of claim 11, wherein the change in the state of the door handle assembly includes a door handle of the door handle assembly being unlocked to provide access to the vehicle.

18. A printed circuit board, comprising:
a transceiver configured to:
receive a first signal to indicate a first interaction with a door handle; and
at least partially surround a sensor along a first portion of the printed circuit board;
the sensor configured to detect a second interaction with the door handle; and
one or more processors, coupled with memory, to:
detect at least one of the first interaction or the second interaction; and
cause, responsive to detection of at least one of the first interaction or the second interaction, a change in a state of the door handle.

19. The printed circuit board of claim 18, wherein the printed circuit board is configured to dispose at least partially within the door handle, wherein the first signal includes information to authenticate a device associated with transmission of the first signal, and further comprising:
the one or more processors to:
receive, from the transceiver, at least one second signal which includes (i) the information to authenticate the device and (ii) an indication of the first interaction;
authenticate, based at least on a match between the information to authenticate the device and one or more sets of information stored in the memory, the device; and
transmit, to the door handle, one or more third signals to cause the change in the state of the door handle.

20. The printed circuit board of claim 18, further comprising:
the transceiver configured to transmit at least one second signal to prompt a device to transmit the first signal, wherein the at least one second signal is detectable by the sensor, and wherein detection of the at least one second signal, by the sensor, causes the sensor to transmit at least one third signal; and
the one or more processors to:
receive, from the sensor, the at least one third signal; and
execute a filter function to distinguish the at least one third signal from at least one fourth signal which indicates the second interaction.
